(19) United States
(12) Patent Application Publication
(10) Pub. No.: US 2002/0078959 A1
(43) Pub. Date: Jun. 27, 2002

(54) Compressed air breathing apparatus

(76) Inventor: Andreas Haeuser, Berlin (DE)

Correspondence Address: WOOD, PHILLIPS, 500 W. Madison Street, Suite 3800, Chicago, IL, 60661, US

(21) Appl. No.: 09/951,116

(22) Filed: Sep. 13, 2001

(30) Foreign Application Priority Data
Sep. 15, 2000 (DE) 100 46 516.1-22

(51) Int. Cl. A62B 7/00; A62B 9/00

(52) U.S. Cl. 128/205.22

(57) ABSTRACT

In a compressed air breathing apparatus comprising a base plate (1) and at least one compressed air bottle (6) attached to it using a fastening strip (5) and an additional fixing device, a high-pressure fitting (10) at said compressed air bottle is connected to a fixing piece (9) comprising a bridge (9b) and at least one latch plate (9c), and said fixing piece (9) can be locked into a mounting hole provided in said base plate (1). The mounting hole has the shape of a keyhole, and so the fixing piece inserted into it, which may also comprise two latch plates placed at a distant from each other thus forming a fixing groove (9a), is locked into the slit-shaped part of said mounting hole. In this way, even multiple compressed air bottles can be fastened safely and replaced fast and easily.

### DESCRIPTION

This invention relates to a compressed air breathing apparatus comprising a base plate, at least one compressed air bottle that is detachably mounted to said base plate using a fastening strap and an additional fixing device and has a high-pressure fitting with a pressure reducer connected to it, and a respirator fitting.

Such compressed air breathing apparatuses are used by people who have to be in toxic, low-oxygen, or otherwise hazardous atmospheres and are usually exposed to high physical strain. For example, fire fighters are equipped with such compressed air breathing apparatuses when fighting fires. The multitude of movements a fire fighter must perform when equipped with a compressed air breathing apparatus does not only require firm fit of the base plate strapped to the wearer's back, but also of the compressed air bottle that is detachably mounted to said base plate, or even multiple compressed air bottles of various sizes as may be required, so that the respective person will not be restricted in movement while performing his/her dangerous job, or exposed to extra risk caused by loosely fitting compressed air bottles. In addition, it is often vital in such risky jobs to be able to mount the compressed air bottle to the base plate or replace it fast and easily. This is all the more important when multiple compressed air bottles are equipped and have to he held in a stable position at the base plate throughout the job.

In known designs of compressed air breathing apparatuses, the pressure reducer is rigidly mounted to the base plate while the compressed air bottle is held at the base plate by its connection to the pressure reducing valve and an additional fastening strap that is connected to the upper section of the base plate. It therefore takes considerable time to mount or replace a compressed air bottle. However, when multiple compressed air bottles that may even differ in shape and in size are to be mounted to the base plate, complex teo and/or angular fittings have to be inserted between the pressure reducer and each compressed air bottle to connect said bottles to the pressure reducer and mount them to the base plate. At the same time, mounting or replacing compressed air bottles becomes more complicated or takes longer. Moreover, the pressure reducer via which said compressed air bottle is to be fastened to the base plate may come loose or be placed at an inappropriate position for mounting the compressed air bottle(s) required so that these cannot be fastened safely, or not be mounted at all.

It is therefore the problem of this invention to provide a compressed air breathing apparatus with such a system of mounting compressed air bottles to the base plate that multiple compressed air bottles, even bottles of various sizes, can be mounted easily and safely and replaced in a minimum amount of time.

This problem is solved according to the invention by the compressed air breathing apparatus comprising the characteristics described in claim 1.

The subordinate claims disclose further important characteristics and advantageous improvements of the invention.

The general concept of the invention is to provide at least one mounting hole in the lower section of the base plate and a fixing piece protruding in a generally horizontal position from the high-pressure fitting at the compressed air bottle that fastens said compressed air bottle to prevent horizontal and vertical movement after the fixing piece has been inserted into the mounting hole, thereby ensuring fast mounting and safe retention of the compressed air bottle(s).

Multiple compressed air bottles that may differ in shape and size can be independently mounted to the base plate without requiring extra tools by providing multiple mounting holes in the base plate and by molding a preferably one-piece fixing piece that can be interlocked with these mounting holes to the high-pressure fitting of each compressed air bottle.

The pressure reducer is either integrated into the high-pressure fitting or separated from it by a high-pressure line.

The mounting hole in the base plate has the shape of a keyhole with a generally circular plug-in aperture followed by a narrow locking slit. The fixing piece comprises at least one latch plate on a narrow bridge that is about as wide as the locking slit, said latch plate fitting tightly to the base plate behind the locking slit after the fixing piece has been inserted into the plug-in aperture, thereby fastening the compressed air bottle at its lower section while its upper section is conventionally held by a fastening strip.

According to another characteristic of the invention, two latch plates are placed on the bridge at a distance from each other that engage the base plate near the locking slit.

The inner sides of these latch plates may be cone-shaped to easily slide into the locking slit and be vertically jammed in for locking purposes.

An advantageous improvement of the invention can be a locking slit that is wholly or partly beveling off the vertical line, or curved, thus further limiting any vertical movement of the compressed air bottle.

An embodiment of the invention that illustrates other characteristics and advantageous designs shall be explained in greater detail with reference to the figures. Wherein:

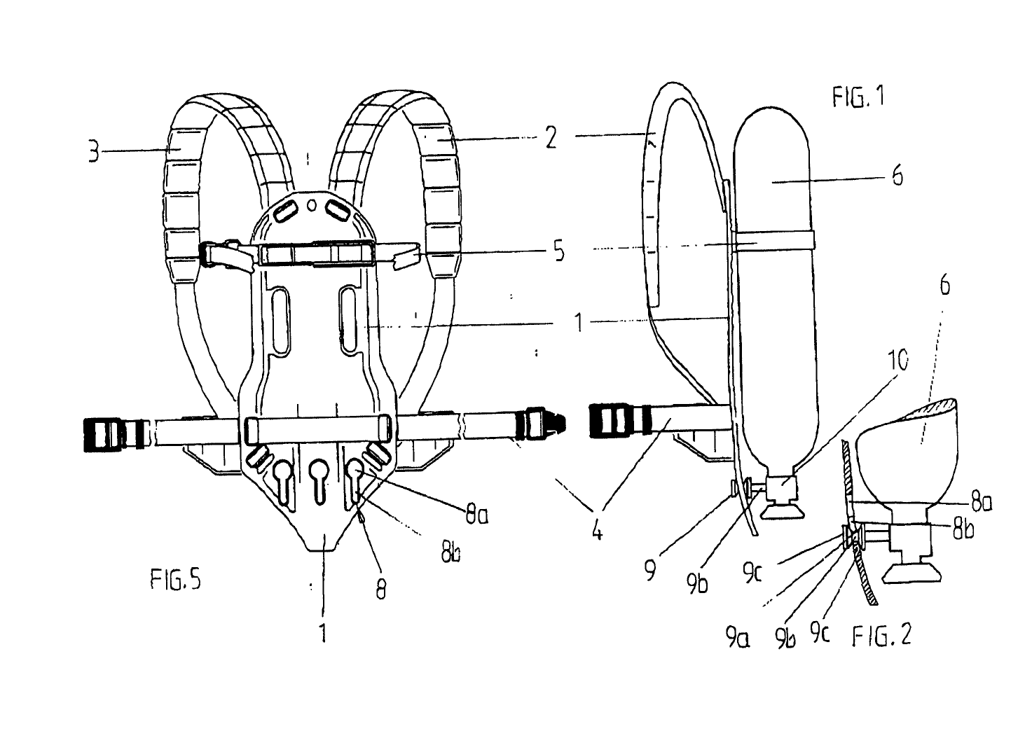

FIG. 1 shows a side view of a compressed air breathing apparatus with a single compressed air bottle mounted to the base plate according to the invention;

FIG. 2 shows a detailed view of the mounting system for the lower section of the compressed air bottle with a fixing piece formed by two latch plates on a bridge;

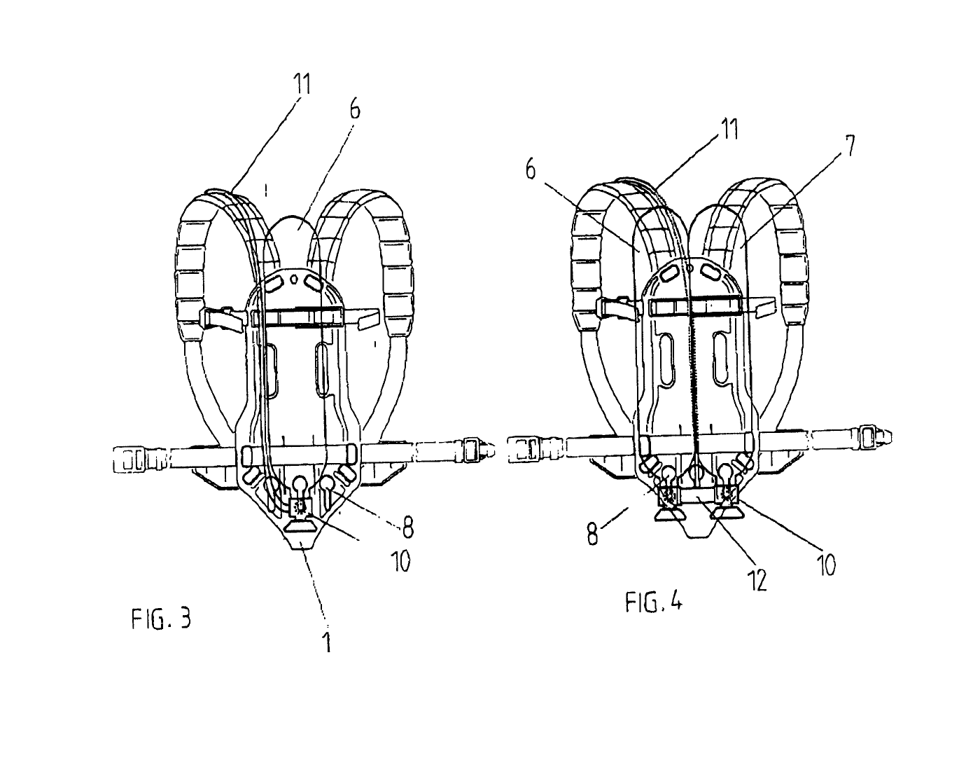

FIG. 3 shows a front view of the compressed air breathing apparatus according to FIG. 1;

FIG. 4 shows a front view of a compressed air breathing apparatus with two compressed air bottles mounted to the base plate; and

FIG. 5 shows a front view of a base plate without compressed air bottles mounted to it.

As shown in the figure, the compressed air breathing apparatus comprises a base plate 1 with two back straps 2, 3 and a waist strap 4 for tying it to a wearer's back as well as a fastening strap 5 for fixing one or two compressed air bottles 6, 7 to the upper section of said base plate 1. As FIG. 5 shows, the lower section of the base plate 1 comprises three keyhole shaped mounting holes 8, each formed by a circular plug-in aperture 8a on the top and a locking slit 8b underneath, the latter running in vertical direction here. The width of locking slit 8b is clearly smaller than the diameter of the plug-in aperture 8a. Unlike the representation in the figure, the slit may also run at an angle to the vertical line or start out in vertical direction and than become diverted at an angle (or vice versa), or run in a different way, for example, form a curve.

A high-pressure fitting 10 with an integrated pressure reducer (not shown) from which a medium pressure line 11 runs to a respiratory fitting (not shown) for a user is mounted to the compressed air bottle 6, 7. An external pressure reducer may also be connected via a high-pressure line to said high-pressure fitting 10.

The high-pressure fitting 10 is connected via a bridge 9b with two latch plates 9c placed at a distance from each other on said bridge to form a fixing groove 9a. Thus a fixing piece 9 for holding the compressed air bottle(s) 6, 7 in the 9 locking slit 8b of base plate 1 is molded in one piece to the high-pressure fitting 10 on the compressed air bottle. The diameter of the latching plates 9c, which have a cone-shaped inner side in the embodiment described here, is slightly smaller than the diameter of the plug-in aperture 8a while the diameter of that part of bridge 9b that is engaged between the latch plates 9c is equal to or slightly smaller than the width of the locking slit 8b, and the length of that bridge part is about the same as the thickness of base plate 1.

Now a compressed air bottle 6, 7 equipped with a fixing piece 9 on its high-pressure fitting 10 can be easily fastened by inserting the fixing piece into the plug-in aperture 8a of the mounting hole 8 and subsequent lowering of the compressed air bottles between the two latch plates 9c into the locking slit 8d, which prevents it from moving in horizontal directions while its vertical movement is blocked by gravitation or a non-vertical design of the locking slit 8b. The fastening strap 5 holds the compressed air bottle(s) at their upper section.

According to FIGS. 3 to 5, the base plate 1 comprises three keyhole-shaped mounting holes 8 positioned on the same level next to each other, and according to FIG. 3 a single compressed air bottle is mounted to the base plate 1 using the center mounting hole 8. However, as FIG. 4 shows, two compressed air bottles 6, 7 that may differ in shape and size can be plugged separately into the left and right mounting holes 8 of that same base plate. The two high-pressure fittings 10 may be connected via a pressure reducer 12 from which a medium pressure line 11 leads to the respiratory fitting (not shown) for the respective user. It is also conceivable that a joint fixing piece is mounted to the joint pressure reducer 12 in order to plug both compressed air bottles 6, 7 into a single (center) mounting hole.

The invention is not restricted to the embodiment described above, as various modifications regarding the shape, number, and arrangement of the mounting holes and the specific design of the fixing piece are conceivable within the general concept of the invention. For example, embodiments comprising just one latch plate or a different shape of the latch plate could be envisaged.

1. A compressed air breathing apparatus that consists of a base plate, at least one compressed air bottle that is detachably mounted to said base plate using a fastening strap and an additional fixing device and has a high-pressure fitting with a pressure reducer connected to it, and a respirator fitting, characterized in that at least one mounting hole (8) is provided in said base plate (1) and that a fixing piece (9) that can be locked into said mounting hole (8) protrudes in a generally horizontal direction from said high-pressure fitting (10).

2. The compressed air breathing apparatus according to claim 1, characterized in that said mounting hole (8) has a keyhole design as it is provided with a generally circular plug-in aperture (8a) followed by a locking slit (8b), and that said fixing piece (9) comprises at least one latch plate (9c) that is linked to said high-pressure fitting (10) via a bridge (9b) so that, after insertion into said plug-in aperture (8a), it locks into said locking slit (8b) and fixes said compressed air bottle (6, 7) to the lower section of said base plate (1).

3. The compressed air breathing apparatus according to claim 2, characterized in that said bridge (9b) can be jammed, latched, or held by friction and/or gravitation in said locking slit (8b).

4. The compressed air breathing apparatus according to claim 2, characterized in that said locking slit (8b) is wholly or partly beveling off the vertical line, or curved, or downward graded.

5. The compressed air breathing apparatus according to claim 2, characterized in that two latch plates (9c) placed at a distance from each other on said bridge (9b) and forming a fixing groove (9a) are provided and that said base plate (1) engages in said fixing groove (9a) at the locking slit (8b).

6. The compressed air breathing apparatus according to claim 5, characterized in that the two latch plates (9c) of said fixing piece (9) are designed as cylinders along the perimeter of which the fixing groove (9a) runs.

7. The compressed air breathing apparatus according to claims 5 and 6, characterized in that the latch plates (9c) of said fixing piece (9) form a double cone with a tapering fixing groove (9a), and that the bridge (9b) runs within said groove.

8. The compressed air breathing apparatus according to any one of claims 1 through 7, characterized in that two or more mounting holes (8) are provided in said base plate (1) to accommodate at least two compressed air bottles (6, 7) that may differ in size.

9. The compressed air breathing apparatus according to claim 8, characterized in that said mounting holes (8) are provided at the same height or at different heights in said base (1).

10. The compressed air breathing apparatus according to claim 1, characterized in that the pressure reducer is integrated into said high-pressure fitting (10) and connected to the respiratory fitting via a medium pressure line (11).

11. The compressed air breathing apparatus according to claim 1, characterized in that the pressure reducer is separated from said high-pressure fitting (10) by a high-pressure line.
